(19) United States
(12) Patent Application Publication
(10) Pub. No.: US 2010/0178110 A1
(43) Pub. Date: Jul. 15, 2010

(54) DEVICE FOR PROTECTING A COASTLINE

(75) Inventors: Hans Ulrich Schmidt, Osnabrueck (DE); Hans-Juergen Reese, Damme (DE); Johann Leitner, Olching (DE); Joachim Roser, Mannheim (DE); Andrea Eisenhardt, Vechta (DE); Erik Pasche, Hamburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/063,825

(22) PCT Filed: Aug. 23, 2006
(86) PCT No.: PCT/EP06/65587

§ 371 Date: Feb. 14, 2008

(30) Foreign Application Priority Data
Sep. 1, 2005 (DE) 10 2005 041 764.7

(51) Int. Cl. E02B 3/04; B23P 17/04; E04B 1/16

(52) U.S. Cl. 405/30; 29/428; 264/35

(57) ABSTRACT

The invention relates to an apparatus for coastal protection, comprising at least one porous composite of stones and plastics which is fixed at a point.

The invention relates to an apparatus for protecting sea coasts from tidal waves.

The protection of coasts, in particular of sea coasts or the areas where rivers flow into the sea, is necessary in many regions since considerable damage can be caused by storm surges or tsunamis.

Since the mangrove forests which provide natural protection from such natural events have been eliminated in many areas, greater damage occurs. Extensive reafforestation of the mangrove forests in the affected regions is very difficult and is particularly time-consuming, so that this measure cannot offer rapid protection.

Artificial protection, generally by means of structures, is therefore required.

Artificial reefs, generally concrete bodies, are often erected in the region of the coast for protection from storm surges or tsunamis. These act as underwater breakwaters and therefore do not project out of the water. The artificial reefs are dimensioned so that the waves build up only at the concrete body and then break as in a reef. High stability and good permeability are important. Methods of construction to date meet this requirement only to a limited extent since the loosely stacked concrete bodies can be torn from the composite by the waves or only deflect the waves without breaking them.

A further possibility is the construction of breakwater systems. In this case, however, there is not only ecological impairment but also visual impairment of the coastal sections, so that this measure is inappropriate particularly in areas which have been opened up to a considerable extent to tourism.

A number of attempts to solve these problems is known. Thus, U.S. Pat. No. 4,130,994 describes a coastal reef or floating breakwater in which a number of disks capable of floating are bound to flexible belts capable of floating. These belts are then mounted about 6 to 18 feet below the surface of the water and are intended in this way to reduce the erosion along the coastline. However, this possibility is technically very complicated and has low mechanical stability.

JP 02308005 describes the possibility of applying a synthetic resin, for example acrylic resin, epoxy resin or polyurethane, to the surface of a concrete block and a metal film thereon by flame lamination. This reinforced block can be used as a breakwater and has very good resistances to sea water. However, this solution is also technically complicated and, since the block is designed as a compact structure, offers only limited protection.

JP 2001152153 describes a composition for embedding chemicals based on polyurethane for stabilizing the bottom or for artificial structures which are used for stabilizing or reinforcing water protection apparatuses. The composition is distinguished by high strength and hardness and has very good permeability to water. Silicate serves as a means for imparting hydrophobic properties.

JP 2002047490 describes a method for stabilizing structures for consolidating coasts. Holes are drilled in the stones and a silicate and a polyisocyanate are introduced into these holes. However, this method is complicated and is practicable only with the use of very large stones.

It was an object of the present invention to find a possibility for protecting coasts from storm surges or tsunamis, which offers effective protection and can be put into practice with little effort.

The object could surprisingly be achieved by an apparatus comprising at least one porous composite of stones and plastics which is firmly bonded to the substrate and is thus fixed at a point.

The invention accordingly relates to an apparatus for coastal protection, in particular protection from flooding, in particular storm surges or tsunamis, comprising at least one porous composite of stones and plastics which is fixed at a point.

The molding consists of stones which are bonded to one another by means of a plastic. The plastics may be, for example, polyurethanes, epoxy resins, unsaturated polyester resins, acrylates and methacrylates. Polyurethane is preferably used.

The stones are preferably rubble. The stones generally have a size of from 1 to 50 cm, preferably from 1 to 20 cm, particularly preferably from 2 to 15 cm, in particular from 2.5 to 6.5 cm.

The stones are firmly bonded to one another by the plastic only at their contact surfaces. Consequently, the molding is porous and the water can flow into the interior of the molding.

The stones are only superficially covered with the plastic. The layer of the plastic on the stones is generally only a few millimeters, preferably not more than 5 mm, in particular from 0.1 to 5 mm, thick. As a result, only a small amount of plastic is required for the composite body. Nevertheless, the composite of the stones with the plastic is so strong that it also withstands high stress, as occurs during storm surges or tsunamis.

Since the water can flow into the porous composite, the energy with which the water strikes the composite body is better absorbed by the deflection of the water into cavities and does not lead to destruction of the molding. Moreover, the power of the waves is greatly reduced thereby.

The fixing of the composites is preferably effected by firmly bonding the porous composite to a structure let into the ground. This may be a foundation present at the bottom of the sea.

Furthermore, the structure may be a construction preferably provided with passages and let into the bottom of the sea.

The structure let into the bottom of the sea preferably consists of concrete. Masonry is in principle also possible. However, this is less stable than concrete and therefore not preferred. The structure may also consist of compressed materials, for example recycled material.

In a further embodiment, the structure may also be a metal construction in which the composite is fastened. Said construction can be fastened directly to the bottom of the sea. However, it is also possible to fasten it on a foundation, for example of concrete.

The fastening of the molding on the foundation can be effected by fixing the molding on the surface of the structure by a fastening means, for example by a concrete mix or by an adhesive, for example a plastic adhesive, which is applied in liquid or pasty form and cures. Alternatively or additionally to this fastening, fixing of the molding by means of a metal construction can also be effected. Said metal construction may comprise, for example, a metal grid, metal nets or a metal cage. The metal used must not be corrosive. The fixing can also be effected by means of sheet pile boxes or similar apparatuses which at least partly surround the structure and the molding.

For better fixing of the moldings, an indentation which receives the molding may be present on the surface of the structures.

The apparatus according to the invention for protecting the coast can preferably be installed in such a way that it is present completely below the surface of the water. Thus, there is no impairment at all of the view of the corresponding coastal section. Among coastal sections with tides, it is possible to install the apparatus according to the invention in such a way that it is present above the surface of the water at ebb tide.

The size and shape of the apparatus according to the invention and hence the force which has to be absorbed by this apparatus depend on the respective flow conditions, the nature of the coast and the various other parameters. Such apparatuses would therefore always have to be adapted individually to the circumstances present on site.

The production of the apparatus according to the invention can be effected in various ways. First, the foundation required for fixing is usually let into the bottom. This can be effected in a conventional and known manner.

The composite body is applied to this structure so that it cannot be removed from its place by the waves. This can be effected as described above.

The production of the composite bodies can also be carried out in various ways.

In one embodiment of the production of the composite bodies, these can be produced as moldings and, after their production, applied to the foundation.

In the production of these moldings, the mixture of the stones with the liquid starting components of the plastic is introduced into a mold which is preferably open at the top, in which mold the plastic cures. The moldings preferably have a size such that they can be transported without problems and can be applied to the foundation, of 100+50×100+50×15+10 cm.

In the production of the moldings, the stones can be introduced into the mold and the liquid starting components of the plastics can be applied to this bed. There, they wet the surface of the stone and cure to give the final plastic. In a preferred embodiment of the production, the stones are mixed with the liquid starting components of the plastics in a mixing device and the stones wetted in this manner are introduced into the mold, where they cure to give the molding. The advantages of this embodiment are firstly the better mixing; secondly, moldings having a greater thickness can be produced. The time for the mixing should be at least such that the stones are wetted as completely as possible with the liquid mixture but no so long that the plastic has cured. In addition, those stones which have loosely adhering impurities on their surface can also be used. As a result of the mechanical stress during the mixing process, these impurities are removed from the surface of the stones and therefore can no longer adversely affect the adhesion of the stones to one another.

The composite body which has formed can be applied to the foundation and fixed there as described above.

In another embodiment of the production of the apparatus for protecting coasts, the moldings are produced directly at their place of use. For this purpose, the stones are mixed with the liquid starting components of the plastics and applied to the foundation, where they cure. It is advantageous to mix the stones, as described above, with the liquid starting components of the plastics in a mixer and to apply this mixture to the foundation, where it cures. Strong bonding to the foundation takes place simultaneously.

Plastics which may be used are the polymers described above. In order to achieve good long-term stability, the plastics should be rendered hydrophobic.

Preferably used plastics are polyurethanes and epoxy resins.

In a preferred embodiment of the invention, plastics used are in particular compact polyurethanes.

Regarding the preferably used polyurethanes, the following may be stated.

In the context of the present invention, components of the polyurethanes are understood very generally as meaning compounds having free isocyanate groups and compounds having groups which are reactive with isocyanate groups. Groups which are reactive with isocyanate groups are generally hydroxyl groups or amino groups. Hydroxyl groups are preferred since the amino groups are very reactive and the reaction mixture therefore has to be processed rapidly. The products formed by reaction of these components are referred to below generally as polyurethanes.

In both process variants, it is unnecessary for the stones to be present in dry form. Surprisingly, good adhesion between the polyurethane and the stones can be obtained also in the presence of wet stones and even under water.

Polyurethanes used may be the conventional and known compounds of this type. The preparation of these materials is effected by reacting polyisocyanates with compounds having at least two active hydrogen atoms. Polyisocyanates which may be used are in principle all polyisocyanates, mixtures and prepolymers which are liquid at room temperature and have at least two isocyanate groups.

Aromatic polyisocyanates are preferably used, particularly preferably isomers of tolylene diisocyanate (TDI) and of diphenylmethane diisocyanate (MDI), in particular mixtures of MDI and polyphenylene polymethylene polyisocyanates (crude MDI). The polyisocyanates may also be modified, for example by incorporating isocyanurate groups and in particular by incorporating urethane groups. The last-mentioned compounds are prepared by reacting polyisocyanates with less than the stoichiometric amount of compounds having at least two active hydrogen atoms and are usually referred to as NCO prepolymers. Their NCO content is in general in the range of from 2 to 29% by weight.

In general, polyfunctional alcohols, so-called polyols, or less preferably, polyfunctional amines are used as compounds having at least two hydrogen atoms reactive with isocyanate groups.

In a preferred embodiment of the process according to the invention, compact polyurethanes, in particular those treated to render them hydrophobic, are used as polyurethanes. The water repellency can be achieved in particular by adding hydroxy-functional components customary in fat chemistry to at least one of the starting components of the polyurethane system, preferably to the polyol component.

A number of hydroxy-functional components customary in fat chemistry are known and can be used. Examples are castor oil, oils modified with hydroxyl groups, such as grapeseed oil, black cummin oil, pumpkin seed oil, borage seed oil, soybean oil, wheatgerm oil, rapeseed oil, sunflower oil, peanut oil, apricot kernel oil, pistachio kernel oil, almond oil, olive oil, macadamia nut oil, avocado oil, sea buckthorn oil, sesame oil, hazlenut oil, evening primrose oil, wild rose oil, hemp oil, safflower oil, walnut oil, fatty acid esters modified with hydroxyl groups and based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid and cervonic acid. Castor oil and its reaction products with alkylene oxides or ketone-formaldehyde resins are preferably used here. The last-mentioned compounds are sold, for example, by Bayer AG under the name Desmophen® 1150.

A further preferably used group of polyols customary in fat chemistry can be obtained by ring opening of epoxidized fatty acid esters with simultaneous reaction with alcohols and, if appropriate, subsequent further transesterification reactions. The incorporation of hydroxyl groups into oils and fats is effected in the main by epoxidation of the olefinic double bond present in these products, followed by the reaction of the epoxide groups formed with a monohydric or polyhydric alcohol. The hydroxyl group is obtained from the epoxide ring or, in the case of polyfunctional alcohols, from a structure having a larger number of OH groups. Since oils and fats are generally glyceryl esters, parallel transesterification reactions also take place in the case of the above-mentioned reactions. The compounds thus obtained preferably have a molecular weight in the range from 500 to 1500 g/mol. Such products are available, for example, from Henkel.

In a particularly preferred embodiment of the process according to the invention, the compact polyurethane used is one which can be prepared by reacting polyisocyanates with compounds having at least two hydrogen atoms reactive with isocyanate groups, wherein the compounds having at least two reactive hydrogen atoms comprise at least one polyol customary in fat chemistry and at least one phenol-modified aromatic hydrocarbon resin, in particular an indene/coumarone resin. These polyurethanes and their components have such a high water repellency that they can in principle cure even under water.

Preferably used phenol-modified aromatic hydrocarbon resins having a terminal phenol group are phenol-modified indene-coumarone resins, particularly preferably industrial mixtures of aromatic hydrocarbon resins, in particular those which comprise, as a substantial constituent, compounds of the general formula (I)

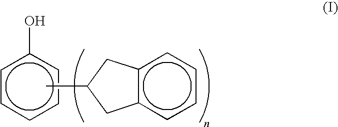

where n is from 2 to 28. Such products are commercially available and are offered, for example, by Rütgers VFT AG under the trade name NOVARES®.

The phenol-modified aromatic hydrocarbon resins, in particular the phenol-modified indene-coumarone resins, generally have an OH content of from 0.5 to 5.0% by weight.

The polyol customary in fat chemistry and the phenol-modified aromatic hydrocarbon resin, in particular the indene-coumarone resin, are preferably used in a weight ratio of from 100:1 to 100:50.

Together with said compounds, further compounds having at least two active hydrogen atoms may be used. Because of their high stability to hydrolysis, polyether alcohols are preferred. These are prepared by conventional and known processes, generally by an addition reaction of alkylene oxides with H-functional starter substances. The concomitantly used polyether alcohols preferably have a functionality of at least 3 and a hydroxyl number of at least 400 mg KOH/g, preferably at least 600 mg KOH/g, in particular in the range of from 400 to 1000 mg KOH/g. They are prepared in a conventional manner by reacting at least trifunctional starter substances with alkylene oxides. Starter substances which may be used are preferably alcohols having at least three hydroxyl groups in the molecule, for example glycerol, trimethylolpropane, pentaerythritol, sorbitol or sucrose. A preferably used alkylene oxide is propylene oxide.

Further conventional constituents, for example catalysts and conventional assistants and additives can be added to the reaction mixture for the preparation of the polyurethanes. In particular, drying agents, for example, zeolites, should be added to the reaction mixture in order to avoid accumulation of water in the components and hence foaming of the polyurethanes. The addition of these substances is preferably effected to the compounds having at least two hydrogen atoms reactive with isocyanate groups. This mixture is frequently referred to in industry as the polyol component. For improving the long-term stability of the composites, it is furthermore advantageous to add agents to prevent attack by microorganisms. Moreover, the addition of UV stabilizers is advantageous for avoiding embrittlement of the moldings.

The polyurethanes used can in principle be prepared without the presence of catalysts. For improving the curing, catalysts may be concomitantly used. Catalysts chosen should preferably be those which result in as long a reaction time as possible. As a result, it is possible for the reaction mixture to remain liquid for a long time. As described, it is also possible in principle to work entirely without a catalyst.

The combination of the polyisocyanates with the compounds having at least two hydrogen atoms reactive with isocyanate groups should be effected in a ratio such that a stoichiometric excess of isocyanate groups, preferably of at least 5%, particularly in the range from 5 to 60%, is present.

The preferably used hydrophobic polyurethanes are distinguished by particularly good processability. Thus, these polyurethanes exhibit particularly good adhesion, in particular to moist substrates, such as wet rock, in particular granite rubble. The curing of the polyurethanes is effected in spite of the granite rubble. The curing of the polyurethanes is effected in virtually compact form in spite of the presence of water. The compact polyurethanes used exhibit completely compact curing even in the case of thin layers.

The preferably used polyurethanes are therefore outstandingly suitable for use in the apparatuses according to the invention for the protection of coasts from storm surges and tsunamis.

Effective protection of endangered coastal sections can be ensured in a simple manner by the apparatuses according to the invention for the protection of coasts from storm surges and tsunamis.

Since wavefronts which run under the surface of the water form in the case of submarine earthquakes, the stability of the apparatuses for coastal protection has to meet high requirements. The apparatuses according to the invention which comprise the porous, hydrophobic composite body can meet these requirements substantially better than conventional coastal protection apparatuses.

We claim:

1. An apparatus for coastal protection, comprising at least one porous composite of stones and plastics which is fixed at a point.

2. The apparatus according to claim 1, wherein the fixing is effected by firmly bonding the porous composite to a structure.

3. The apparatus according to claim 2, wherein the structure is a foundation present at the bottom of the sea or of the river mouth.

4. The apparatus according to claim 2, wherein the structure is a construction provided with passages.

5. The apparatus according to claim 2, wherein the structure consists of concrete.

6. The apparatus according to claim 1, which is present completely below the surface of the water.

7. The apparatus according to claim 1, which is present partly above the surface of the water.

8. The apparatus according to claim 1, wherein the plastic is selected from the group consisting of polyurethanes, epoxy resins, unsaturated polyester resins, acrylates and methacrylates.

9. The apparatus according to claim 1, wherein the plastic is a polyurethane.

10. The apparatus according to claim 1, wherein the plastic is a compact polyurethane.

11. The apparatus according to claim 1, wherein the plastic is a hydrophobic compact polyurethane.

12. The apparatus according to claim 1, wherein the plastic is an epoxy resin.

13. A method for the production of an apparatus according to claim 1, comprising the steps
a) laying of a foundation for a structure on the bottom,
b) application of the one porous composite of stones and plastics to the structure, and, if appropriate,
c) fixing of the porous composite of stones and plastics on the structure.

14. The method according to claim 13, wherein the porous composite of stones and plastics is produced by bringing stones into contact with the liquid starting components of the plastics and allowing the plastic to cure thereafter.

15. The method according to claim 13, wherein the production of the porous composite of stones and plastics is effected on land and the molding thus obtained is introduced to the structure and, if appropriate, fixed.

16. The method according to claim 13, wherein the fixing is effected by applying the liquid starting components of a plastic to the structure and/or the porous composite of stones and plastics and then bringing the composite and the structure into contact, the strong bond being produced by the curing of the plastic.

17. The method according to claim 13, wherein the production of the porous composite of stones and plastics is effected by bringing the stones into contact with the liquid starting components of the plastics and bringing this mixture into contact with the structure, where the plastic cures.

18. The method according to claim 13, wherein the production of the porous composite of stones and plastics is effected by applying the stones to the structure, then adding the liquid starting components of the plastics and then curing the plastics.
